(19) United States
(12) Patent Application Publication
(10) Pub. No.: US 2025/0369810 A1
(43) Pub. Date: Dec. 4, 2025

(54) PRESSURE SENSOR

(71) Applicant: Japan Display Inc., Tokyo (JP)

(72) Inventors: Shinichiro OKA, Tokyo (JP); Junji KOBASHI, Tokyo (JP); Chiharu KABURAGI, Tokyo (JP); Fumiyuki OOKUNI, Tokyo (JP); Takuo KAITOH, Tokyo (JP); Yuta HAGA, Tokyo (JP); Yoshinori AOKI, Tokyo (JP)

(21) Appl. No.: 19/220,685

(22) Filed: May 28, 2025

(30) Foreign Application Priority Data
May 30, 2024 (JP) 2024-088058

(51) Int. Cl. G01L 1/22

(52) U.S. Cl. CPC G01L 1/2287; G01L 1/225

(57) ABSTRACT

According to one embodiment, a pressure sensor includes a plurality of first detection areas and a plurality of second detection areas. Each of the plurality of first detection areas includes a first transistor, a first detection electrode electrically connected to the first transistor, and a first pressure-sensitive layer provided on the first detection electrode. Each of the plurality of second detection areas includes a second transistor, a second detection electrode electrically connected to the second transistor, and a second pressure-sensitive layer provided on the second detection electrode. The first pressure-sensitive layer and the second pressure-sensitive layer have different variation ratios of resistance values in response to applied pressure.

### CROSS-REFERENCE TO RELATED APPLICATIONS

This application is based upon and claims the benefit of priority from Japanese Patent Application No. 2024-088058, filed May 30, 2024, the entire contents of which are incorporated herein by reference.

### FIELD

Embodiments described herein relate generally to a pressure sensor.

### BACKGROUND

Various pressure sensors capable of detecting pressure distribution have been proposed. With respect to these pressure sensors, pressure sensors capable of detecting pressure variations in a wide pressure range are demanded.

### BRIEF DESCRIPTION OF THE DRAWINGS

FIG. 1 is a plan view showing a configuration example of a pressure sensor of the first embodiment.

FIG. 2 is a plan view showing a configuration example of the pressure sensor shown in FIG. 1.

FIG. 3 is a schematic cross-sectional view of the pressure sensor along III-III line in FIG. 2.

FIG. 4 is a circuit diagram view showing an example of circuit configurations of the pressure sensor shown in FIG. 1.

FIG. 5 is a cross-sectional view illustrating a state where an input surface of the pressure sensor shown in FIG. 1 is pressed.

FIG. 6 is a view showing an example of relationships among pressure applied to the input surface and current values.

FIG. 7 is a plan view showing a configuration example of a pressure sensor of the second embodiment.

FIG. 8 is a schematic cross-sectional view of the pressure sensor along VIII-VIII line in FIG. 7.

FIG. 9 is a plan view showing a configuration example of a pressure sensor of the third embodiment.

FIG. 10 is a schematic cross-sectional view of the pressure sensor along X-X line in FIG. 9.

FIG. 11 shows a configuration example of arrangements of detection areas.

FIG. 12 shows a configuration example of arrangements of the detection areas.

FIG. 13 shows a configuration example of arrangements of the detection areas.

### DETAILED DESCRIPTION

In general, according to one embodiment, a pressure sensor has a plurality of first detection areas and a plurality of second detection areas. Each of the plurality of first detection areas includes a first transistor, a first detection electrode electrically connected to the first transistor, and a first pressure-sensitive layer provided on the first detection electrode. Each of the plurality of second detection areas includes a second transistor, a second detection electrode electrically connected to the second transistor, and a second pressure-sensitive layer provided on the second detection electrode. The first pressure-sensitive layer and the second pressure-sensitive layer have different variation ratios of resistance values in response to applied pressure.

This configuration can provide a pressure sensor capable of detecting pressure variations in a wide pressure range.

Embodiments will be described hereinafter with reference to the accompanying drawings.

The disclosure is a mere example, and proper changes within the spirit of the invention, which are easily conceived by a person of ordinary skill in the art, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. In addition, in the specification and drawings, structural elements that function in the same or a similar manner to those described in connection with preceding drawings are denoted by like reference numbers, detailed description thereof being omitted unless necessary.

### First Embodiment

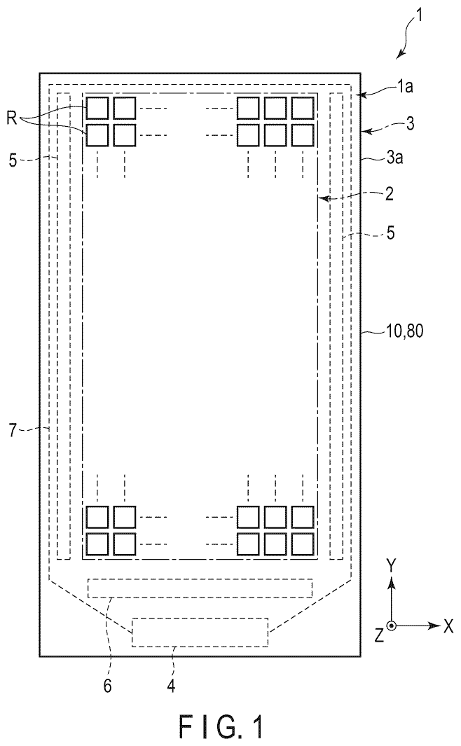

FIG. 1 is a plan view showing a configuration example of a pressure sensor 1 of the present embodiment. For example, a first direction X, a second direction Y, and a third direction Z are orthogonal to one another but may intersect at an angle other than 90 degrees. The first direction X and the second direction Y correspond to, for example, directions parallel to a main surface of a substrate constituting the pressure sensor 1, and the third direction Z corresponds to the thickness direction of the pressure sensor 1. In the present specification, a direction from a substrate 10 to a protective layer 80 is referred to as an “upper side” (or simply, “upper” or “above”) and a direction from the protective layer 80 to the substrate 10 is referred to as a “lower side” (or simply, “lower” or “below”). Expressions such as “a second member on/above a first member” and “a second member under/below a first member” signify that the second member may be in contact with the first member or may be spaced apart from the first member. In addition, an observation position at which the pressure sensor 1 is observed is assumed to be located on the tip side of the arrow indicating the third direction Z, and viewing from the observation position toward the X-Y plane defined by the first direction X and the second direction Y is referred to as a plan view.

In the present embodiment, the pressure sensor 1 is a pressure distribution sensor. The pressure sensor 1 comprises a substrate 10. The substrate 10 is formed in a flat plate shape parallel to the X-Y plane. For example, the substrate 10 has a rectangular shape in plan view.

In the example in FIG. 1, the pressure sensor 1 comprises a protective layer 80. The protective layer 80 is formed in a flat plate shape parallel to the X-Y plane. The substrate 10 overlaps the protective layer 80 in plan view.

The pressure sensor 1 has an input surface la on its one surface. Pressure is applied to the input surface 1a. In the example in FIG. 1, the pressure sensor 1 has the input surface la on the surface of the protective layer 80 opposite to a surface facing the substrate 10. The pressure sensor 1 detects pressure applied to the input surface 1a.

The input surface 1a comprises a detection

unit 2 for detecting pressure and a non-detection unit 3 formed in a frame shape and surrounding the detection unit 2 in plan view. The detection unit 2 has a plurality of detection areas R. In the example in FIG. 1, the plurality of detection areas R are arrayed in the first direction X and the second direction Y. The plurality of detection areas R have a first detection area R1, a second detection area R2, and a third detection area R3.

The pressure sensor 1 further comprises a connection unit 4, a gate line drive circuit 5, a signal line select circuit 6, a common wire 7, and the like. The pressure sensor 1 comprises gate lines 8 and signal lines 9 (both not shown). The connection unit 4, the gate line drive circuit 5, the signal line select circuit 6, the common wire 7, the gate lines 8, and the signal lines 9 are provided between the substrate 10 and the protective layer 80. Each of the connection unit 4, the gate line drive circuit 5, the signal line select circuit 6, and the common wire 7 overlaps the non-detection unit 3 in plan view.

The connection unit 4 connects the pressure sensor 1 with a drive integrated circuit (IC) in the exterior of the pressure sensor 1. The drive integrated circuit (IC) is not shown. The drive IC may be mounted as a chip on film (COF) on a flexible printed substrate or a rigid substrate both connected to the connection unit 4. The drive IC may be mounted as a chip on glass (COG) in an area overlapping the non-detection unit 3 of the substrate 10.

The gate line drive circuit 5 drives the plurality of gate lines 8 based on various control signals from the drive IC. The gate line drive circuit 5 sequentially or simultaneously selects the gate lines 8 and then supplies the selected gate lines 8 with gate drive signals.

The signal line select circuit 6 is a switch circuit that sequentially or simultaneously selects the signal lines 9. The signal line select circuit 6 is, for example, a multiplexer. The signal line select circuit 6 connects the selected signal lines 9 with the drive IC based on the select signals supplied from the drive IC.

The common wire 7 supplies the common electrode with a prescribed voltage and is arrayed along an outer edge 3a of the non-detection unit 3. The common wire 7 is connected to the drive IC via the connection unit 4 and is supplied with a constant voltage from the drive IC.

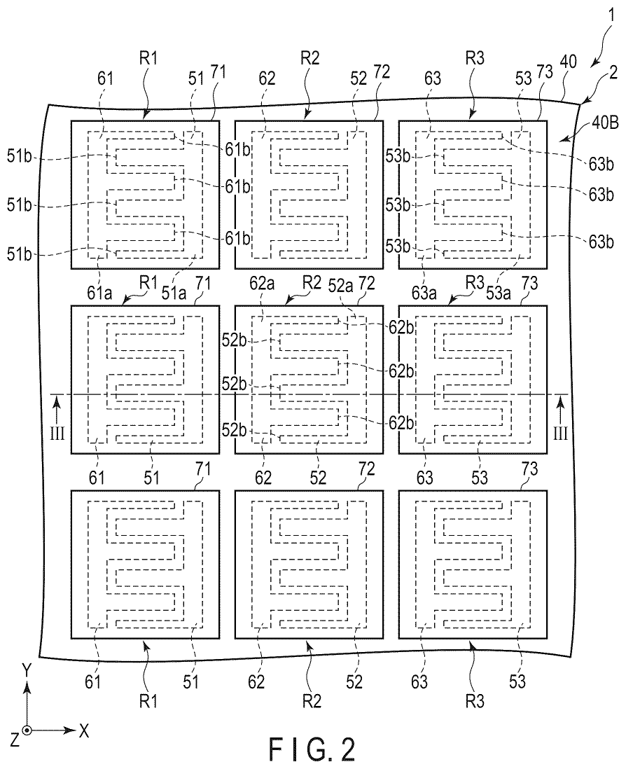

FIG. 2 is a plan view showing a configuration example of the pressure sensor 1 shown in FIG. 1. The following describes a detection unit 2 of the pressure sensor 1. FIG. 2 omits the illustration of the protective layer 80.

The pressure sensor 1 has a plurality of first detection areas R1, a plurality of second detection areas R2, and a plurality of third detection areas R3. In the example in FIG. 2, the plurality of first detection areas R1 are arrayed in the second direction Y, the plurality of second detection areas R2 are arrayed in the second direction Y, and the plurality of third detection areas R3 are arrayed in the second direction Y. Further, the first detection areas R1, the second detection areas R2, and the third detection areas R3 are arrayed in this order in the first direction X. The arrangement of the detection areas R is described in detail later.

The first detection area R1 comprises a detection electrode 51, a common electrode 61, a pressure-sensitive layer 71, and a transistor 31 (not shown). The detection electrode 51 comprises an electrode 51a extending in the second direction Y, and a plurality of electrodes 51b extending in the first direction X from the electrode 51a. The common electrode 61 comprises an electrode 61a extending in the second direction Y, and a plurality of electrodes 61b extending in the first direction X from the electrode 61a. The electrodes 51b and the electrodes 61b are alternately arrayed in the second direction Y.

The pressure-sensitive layer 71 overlaps the first detection area R1 in plan view. In the example in FIG. 2, the pressure-sensitive layer 71 covers the entirety of both of the detection electrode 51 and the common electrode 61. For example, the pressure-sensitive layer 71 has a rectangular shape in plan view.

The second detection area R2 comprises a detection electrode 52, a common electrode 62, a pressure-sensitive layer 72, and a transistor 32 (not shown). The detection electrodes 52 comprises an electrode 52a extending in the second direction Y and a plurality of electrodes 52b extending in the first direction X from the electrode 52a. The common electrode 62 comprises an electrode 62a extending in the second direction Y and a plurality of electrodes 62b extending in the first direction X from the electrode 62a. The electrodes 52b and the electrodes 62b are alternately arrayed in the second direction Y. The pressure-sensitive layer 72 overlaps the second detection area R2 in plan view. In the example in FIG. 2, the pressure-sensitive layer 72 covers the entirety of both of the detection electrode 52 and the common electrode 62. For example, the pressure-sensitive layer 72 has a rectangular shape in plan view.

The third detection area R3 comprises a detection electrode 53, a common electrode 63, a pressure-sensitive layer 73, and a transistor 33 (not shown). The detection electrode 53 comprises an electrode 53a extending in the second direction Y and a plurality of electrodes 53b extending in the first direction X from the electrode 53a. The common electrode 63 comprises an electrode 63a extending in the second direction Y and a plurality of electrodes 63b extending in the first direction X from the electrode 63a. The electrodes 53b and the electrodes 63b are alternately arrayed in the second direction Y.

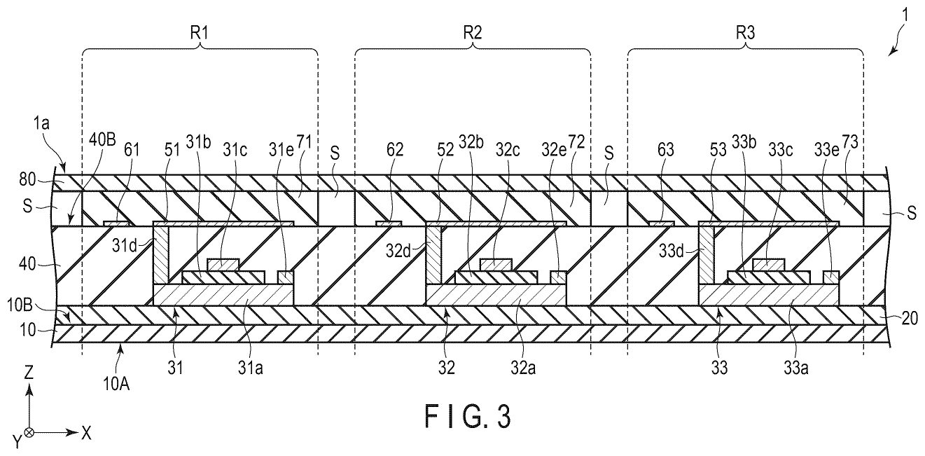

The pressure-sensitive layer 73 overlaps the third detection area R3 in plan view. In the example in FIG. 3, the pressure-sensitive layer 73 covers the entirety of both of the detection electrode 53 and the common electrode 63. For example, the pressure-sensitive layer 73 has a rectangular shape in plan view.

In the example in FIG. 2, the detection electrodes 51, 52, and 53 have the same size in plan view, although these electrodes may have other sizes in plan view. At least one of the detection electrodes 51, 52, and 53 may have a size in plan view different from the others. Further, in the example in FIG. 2, the pressure-sensitive layers 71, 72, and 73 have the same size in plan view, although these pressure-sensitive layers may have other sizes in plan view. At least one of the pressure-sensitive layers 71, 72, and 73 may have a size in plan view different from the others.

FIG. 3 is a schematic cross-sectional view of the pressure sensor 1 along III-III line in FIG. 2.

The pressure sensor 1 comprises the substrate 10, the insulating layer 20, the transistors 31, 32, and 33, the insulating layer 40, the detection electrodes 51, 52, and 53, the common electrodes 61, 62, and 63, the pressure-sensitive layers 71, 72, and 73, and the protective layer 80. The pressure sensor 1 further comprises the connection unit 4, the gate line drive circuit 5, the signal line select circuit 6, and the common wire 7 that are shown in FIG. 1.

The substrate 10 has a main surface (lower surface) 10A and a main surface (upper surface) 10B on the side opposite to the main surface 10A. The main surfaces 10A and 10B are substantially parallel to the X-Y plane. The insulating layer 20 covers the main surface 10B. Each of the transistors 31, 32, and 33 is provided on the insulating layer 20.

The transistor 31 comprises a semiconductor layer 31a, a gate insulating film 31b, a gate electrode 31c, a drain electrode 31d, and a source electrode 31e. The semiconductor layer 31a is provided on the insulating layer 20. The gate insulating film 31b is provided on the semiconductor layer 31a. The gate electrode 31c is provided on the gate insulating film 31b. The drain electrode 31d is provided on the semiconductor layer 31a. The drain electrode 31d is electrically connected to the gate line 8 (not shown). The source electrode 31e is provided on the semiconductor layer 31a. The source electrode 31e is electrically connected to the signal line 9 (not shown).

The transistor 32 comprises a semiconductor layer 32a, a gate insulating film 32b, a gate electrode 32c, a drain electrode 32d, and a source electrode 32e. The semiconductor layer 32a is provided on the insulating layer 20. The gate insulating film 32b is provided on the semiconductor layer 32a. The gate electrode 32c is provided on the gate insulating film 32b. The drain electrode 32d is provided on the semiconductor layer 32a. The drain electrode 32d is electrically connected to the gate line 8 (not shown). The source electrode 32e is provided on the semiconductor layer 32a. The source electrode 32e is electrically connected to the signal line 9 (not shown).

The transistor 33 comprises a semiconductor layer 33a, a gate insulating film 33b, a gate electrode 33c, a drain electrode 33d, and a source electrode 33e. The semiconductor layer 33a is provided on the insulating layer 20. The gate insulating film 33b is provided on the semiconductor layer 33a. The gate electrode 33c is provided on the gate insulating film 33b. The drain electrode 33d is provided on the semiconductor layer 33a. The drain electrode 33d is electrically connected to the gate line 8 (not shown). The source electrode 33e is provided on the semiconductor layer 33a. The source electrode 33e is electrically connected to the signal line 9 (not shown).

The insulating layer 40 covers the insulating layer 20 and the transistors 31, 32, and 33. The insulating layer 40 comprises a surface 40B facing the protective layer 80. The surface 40B is planarized. Though not shown, the connection unit 4, the gate line drive circuit 5, the signal line select circuit 6, the common wire 7, the gate line 8, and the signal line 9 are provided between the main surface 10A and the surface 40B.

Each of the detection electrodes 51, 52, and 53 is provided on the surface 40B. The detection electrode 51 is electrically connected to the drain electrode 31d, and is electrically connected to the transistor 31. The detection electrode 52 is electrically connected to the drain electrode 32d, and is electrically connected to the transistor 32. The detection electrode 53 is electrically connected to the drain electrode 33d, and is electrically connected to the transistor 33.

Each of the detection electrodes 61, 62, and 63 is provided on the surface 40B. The common electrode 61 is adjacent to the detection electrode 51 with a gap in between in the first direction X. The common electrode 62 is adjacent to the detection electrode 52 with a gap in between in the first direction X. The common electrode 63 is adjacent to the detection electrode 53 with a gap in between in the first direction X. The common electrodes 61, 62, and 63 have the same electric potential.

In the pressure sensor 1, the detection electrode 51, and the common electrode 61 are provided on the same plane; the detection electrode 52 and the common electrode 62 are provided on the same plane; and the detection electrode 53 and the common electrode 63 are provided on the same plane. That is, the pressure sensor 1 comprises what is called a parallel-type electrode.

The pressure-sensitive layer 71 covers the detection electrode 51 and the common electrode 61. Further, the pressure-sensitive layer 71 covers the surface 40B between the detection electrode 51 and the common electrode 61. The detection electrode 51 and the common electrode 61 are adjacent to each other via the pressure-sensitive layer 71. The pressure-sensitive layer 72 covers the detection electrode 52 and the common electrode 62. Further, the pressure-sensitive layer 72 covers the surface 40B between the detection electrode 52 and the common electrode 62.

The detection electrode 52 and the common electrode 62 are adjacent to each other via the pressure-sensitive layer 72. The pressure-sensitive layer 73 covers the detection electrode 53 and the common electrode 63. Further, the pressure-sensitive layer 73 covers the surface 40B between the detection electrode 53 and the common electrode 63. The detection electrode 53 and the common electrode 63 are adjacent to each other via the pressure-sensitive layer 73.

In the example in FIG. 3, the pressure-sensitive layer 71 and the pressure-sensitive layer 72 are provided with a gap S in between in the first direction X, and the pressure-sensitive layer 72 and the pressure-sensitive layer 73 are provided with the gap S in between in the first direction X. The surface 40B is exposed in the gap S. Though not shown, a partition formed of an insulating material and the like may be formed in the gap S. Further, the pressure-sensitive layers 71 and 72 may be provided to contact each other, and the pressure-sensitive layers 72 and 73 may be provided to contact each other.

The protective layer 80 covers the pressure-sensitive layers 71, 72, and 73. The protective layer 80 has the input surface la on the surface opposite to the surface facing the substrate 10. For example, the protective layer 80 may cover the entire area of the pressure sensor 1.

In the examples in FIG. 2 and FIG. 3, the pressure sensor 1 has three types of detection areas R, in other words, the first detection area R1, the second detection area R2, and the third detection area R3. The first detection area R1, the second detection area R2, and the third detection area R3 have different types of pressure-sensitive layers. The configuration of the pressure sensor 1 is not limited to this example. The pressure sensor 1 has at least two types of detection areas R.

The substrate 10 is insulating. For example, the substrate 10 is any of a substrate and a film, both formed of glass, resin or the like. The insulating layers 20 and 40 are inorganic or organic insulating films. The protective layer 80 is a substrate that is insulating and flexible. For example, the protective layer 80 is a substrate or a film both formed of a resin and the like.

The detection electrodes 51, 52, and 53 and the common electrodes 61, 62, and 63 are formed of a metal material such as indium tin oxide (ITO), for example.

The pressure-sensitive layers 71, 72, and 73 are formed of an insulating resin containing conductive materials. The conductive materials are, for example, conductive particles. The conductive materials are dispersed in an insulating resin to be spaced apart from one another. For example, the pressure-sensitive layers 71, 72, and 73 are conductive elastomers prepared by mixing rubber member with conductive material. For example, the pressure-sensitive layers 71, 72, and 73 may be formed by applying insulating resin containing conductive materials onto the surface 40B by means of an ink-jet and the like.

When no pressure is applied to such pressure-sensitive layers formed of insulating resin containing conductive material, the conductive materials in the insulating resin are spaced apart from one another. Thus, the pressure-sensitive layer in this state has a great resistance value. When pressure is applied to the pressure-sensitive layer, the insulating resin deforms and thus the conductive materials in the insulating resin are brought into contact with one another or close proximity. This reduces the resistance value of the pressure-sensitive layer. When pressure is further applied to the pressure-sensitive layer and deformation amount of the insulating resin further increases, the amount of the conductive materials that are in contact with one another or close proximity increases. This further reduces the resistance value of the pressure-sensitive layer. In this manner, the resistance value of the pressure-sensitive layer formed of the insulating resin containing the conductive materials varies in response to pressure applied to the pressure-sensitive layer.

The pressure-sensitive layers 71, 72, and 73 have different degrees of variations in resistance values in response to variations in pressure. That is, the pressure-sensitive layers 71, 72, and 73 have different variation ratios of resistance values in response to pressure. Different types of the pressure-sensitive layers can be prepared by adjusting degrees of variations in resistance values in response to variations in pressure. For example, the degrees of variations in resistance values in response to variations in pressure may be adjusted by varying contents of the conductive materials in the insulating resins. Alternatively, the degrees of variations in resistance values in response to variations in pressure may be adjusted by varying conductivities of the conductive materials in the insulating resins. Alternatively, the degrees of variations in resistance values in response to variations in pressure may be adjusted by varying hardnesses of the insulating resins.

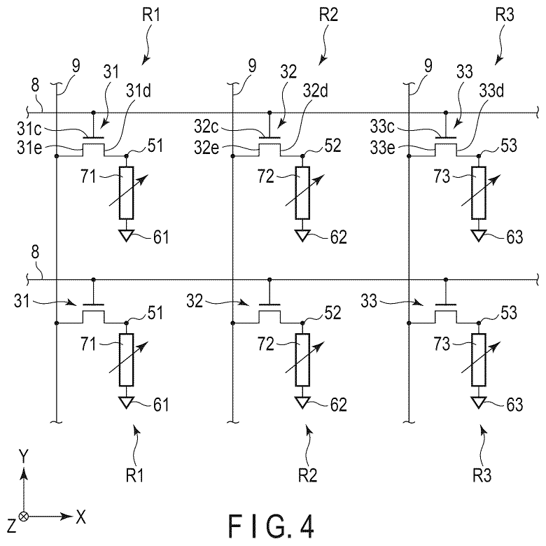

FIG. 4 is a circuit diagram showing an example of circuit configurations of the pressure sensor 1 shown in FIG. 1. As shown in FIG. 4, each of the gate electrodes 31c, 32c, and 33c is electrically connected to the gate line 8. Further, each of the source electrodes 31e, 32e, and 33e is electrically connected to the signal line 9. That is, each of the transistors 31, 32, and 33 is electrically connected to the gate line 8 and the signal line 9.

The gate line 8 extends in the first direction X and is electrically connected to the respective transistors 31, 32, and 33 of the first detection area R1, the second detection area R2, and the third detection area R3, which are arrayed in the first direction X. The signal line 9 extends in the second direction Y, intersects the gate line 8, and is electrically connected to the respective transistors 31, 32, and 33 of the first detection area R1, the second detection area R2, and the third detection area R3, which are arrayed in the second direction Y.

The detection electrode 51 is electrically connected to the drain electrode 31d. The detection electrode 52 is electrically connected to the drain electrode 32d. The detection electrode 53 is electrically connected to the drain electrode 33d.

Scanning the gate line 8 electrically connects each of the detection electrodes 51, 52, and 53 with the signal line 9. Thus, respective values of a current flowing between the detection electrode 51 and the common electrode 61, a current flowing between the detection electrode 52 and the common electrode 62, and a current flowing between the detection electrode 53 and the common electrode 63 can be obtained via the signal line 9. Pressure applied to the first detection area R1, the second detection area R2, and the third detection area R3 can be detected based on the obtained current values.

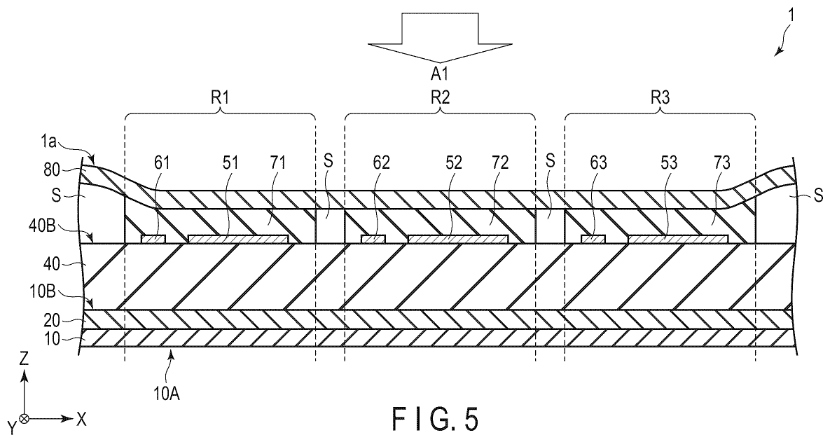

FIG. 5 is a cross-sectional view illustrating a state where the input surface la of the pressure sensor 1 is pressed. FIG. 5 omits the illustration of the transistors 31, 32, and 33.

When the input surface la of the pressure sensor 1 is not pressed, each of the pressure-sensitive layers 71, 72, and 73 has a greater resistance value. In the first detection area R1, the detection electrode 51, and the common electrode 61 are adjacent to each other via the pressure-sensitive layer 71. Thus, when the input surface la is not pressed, the detection electrode 51 and the common electrode 61 are electrically disconnected from each other. Similarly, in such a state, the detection electrode 52 and the common electrode 62 are electrically disconnected from each other in the second detection area R2. Similarly, in such a state, the detection electrode 53 and the common electrode 63 are electrically disconnected from each other in the third detection area R3.

As shown in FIG. 5, for example, when the input surface 1a is pressed by fingers and the like, pressure in a direction from the protective layer 80 to the substrate 10, in other words, in an A1 direction is applied to the input surface 1a. At this time, in the first detection area R1, the pressure-sensitive layer 71 is compressed in the A1 direction. Thus, the conductive materials contained in the pressure-sensitive layer 71 are brought into contact with one another or close proximity. This reduces the resistance value of the pressure-sensitive layer 71.

Thus, a current flows between the detection electrode 51 and the common electrode 61 via the pressure-sensitive layer 71. Similarly, at this time, a current flows between the detection electrode 52 and the common electrode 62 via the pressure-sensitive layer 72 in the second detection area R2. Similarly, at this time, a current flows between the detection electrode 53 and the common electrode 63 via the pressure-sensitive layer 73 in the third detection area R3.

When the pressure in the A1 direction applied to the input surface la increases, in the first detection area R1, the pressure-sensitive layer 71 is further compressed in the A1 direction. This increases the amount of the conductive materials that are brought into contact with one another or close proximity. This reduces the resistance value of the pressure-sensitive layer 71 further and increases a current flowing between the detection electrode 51 and the common electrode 61 via the pressure-sensitive layer 71. That is, as pressure applied to the input surface la increases, a value of a current (current value) flowing between the detection electrode 51 and the common electrode 61 via the pressure-sensitive layer 71 increases in the first detection area R1. Variations in pressure applied to the input surface la can be detected by detecting such variations in the current value. Similarly, in the second detection area R2 and the third detection area R3, variations in pressure applied to the input surface la can be detected.

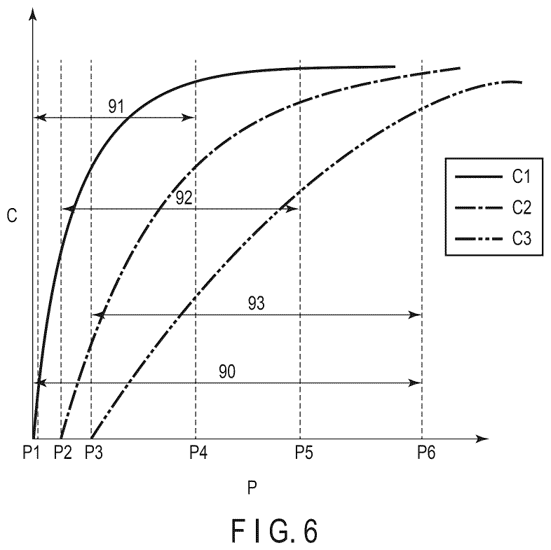

FIG. 6 is a view showing an example of relationships among pressures P applied to the input surface 1a and current values C. In the example in FIG. 6, pressures P1, P2, P3, P4, P5, and P6 are in this order from the smallest to the greatest. C1 refers to a value of a current flowing between the detection electrode 51 and the common electrode 61 via the pressure-sensitive layer 71. C2 refers to a value of a current flowing between the detection electrode 52 and the common electrode 62 via the pressure-sensitive layer 72. C3 refers to a value of a current flowing between the detection electrode 53 and the common electrode 63 via the pressure-sensitive layer 73.

The pressure-sensitive layer 71, 72, and 73 have different variation ratios of resistance values in response to pressures P. Thus, with respect to the relationships among the pressures P and the current values C, the current value C1, the current value C2, and the current value C3 are shown by different lines, for example, as shown in FIG. 6. That is, how a current value C varies in response to a pressure P differs between the first detection area R1, the second detection area R2, and the third detection area R3.

In the example in FIG. 6, with the pressure P falling within the range of P1 to P4, the current value C1 increases as the pressure P increases. When the pressure P exceeds the pressure P4, variation ratio of the current value C1 in response to the pressure P decreases. That is, in the first detection area R1, variations in the pressure P falling within a range 91 (in other words, P1 to P4) can be detected with high accuracy.

In the example in FIG. 6, with the pressure P falling within the range of P1 to P2, the current value C2 hardly varies. When the pressure P falls within the range of P2 to P5, the current value C2 increases as the pressure P increases. When the pressure P exceeds the pressure P5, variation ratio of the current value C2 in response to the pressure P decreases. That is, in the second detection area R2, variations in the pressure P falling within a range 92 (in other words, P2 to P5) can be detected with high accuracy.

In the example in FIG. 6, with the pressure P falling within the range of P1 to P3, the current value C3 hardly varies. When the pressure P falls within the range of P3 to P6, the current value C3 increases as the pressure P increases. When the pressure P exceeds the pressure P6, the variation ratio of the current value C3 in response to the pressure P decreases. That is, in the third detection area R3, variations in the pressure P falling within a range 93 (in other words, P3 to P6) can be detected with high accuracy.

In this manner, the first detection area R1, the second detection area R2, and the third area 3 have different ranges in which the variations in the pressure P can be detected with high accuracy. In the example in FIG. 6, the ranges 91, 92, and 93 partially overlap one another, although the ranges 91, 92, and 93 may or may not be successive.

The present embodiment can provide a pressure sensor capable of detecting pressure variations in the broad range 90.

The pressure sensor 1 has the plurality of first detection areas R1 and the plurality of second detection areas R2. The pressure-sensitive layer 71 of the first detection area R1 and the pressure-sensitive layer 72 of the second detection area R2 have different variation ratios of resistance values in response to pressure. That is, how a current value C varies in response to a pressure P applied to the input surface la differs between the current value C1 and the current value C2. In the example in FIG. 6, the current value C1 varies in response to the pressure P in the range 91 (the pressures P1 to P4), and the current value C2 varies in response to the pressure P in the range 92 (the pressures P2 to P5). That is, in the first detection area R1, the pressure variations can be detected with high accuracy in the range 91 (the pressures P1 to P4). Similarly, in the second detection area R2, the pressure variations can be detected with high accuracy in the range 92 (the pressures P2 to P5). In this manner, the first detection area R1 and the second detection area R2 have different ranges in which the pressure variations can be detected with high accuracy. The pressure sensor 1 has the first detection area R1 and the second detection area R2 with these features. Thus, the pressure variations can detect the pressure variations with high accuracy in the broad range, the range of P1 to P5. Further, the pressure sensor 1 has the plurality of third detection areas R3 in which the pressure variations in the range 93 of the pressure P3 to the pressure P6 can be detected with high accuracy. Thus, the pressure sensor 1 can detect the pressure variations with high accuracy in the range 90, from the pressure P1 to the pressure P6.

In this manner, the present embodiment can detect the pressure variations with high accuracy in the broad range from low pressure to high pressure.

### Second Embodiment

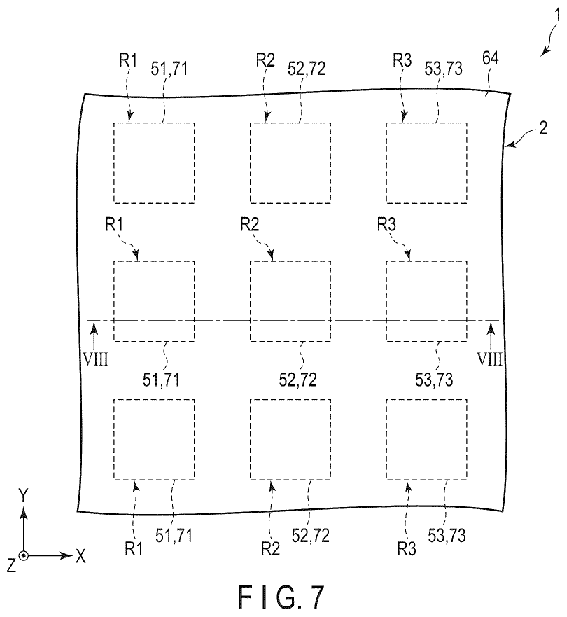

FIG. 7 is a plan view showing a configuration example of a pressure sensor 1 of the second embodiment. Configurations corresponding to those in the first embodiment adopt the above explanations and explanations of these corresponding configurations are omitted. The following describes a detection unit 2 of the pressure sensor 1. FIG. 7 omits the illustration of a protective layer 80.

The pressure sensor 1 has a plurality of first detection areas R1, a plurality of second detection areas R2, and a plurality of third detection areas R3. In the example in FIG. 7, the plurality of first detection areas R1 are arrayed in the second direction Y, the plurality of second detection areas R2 are arrayed in the second direction Y, and the plurality of third detection areas R3 are arrayed in the second direction Y. Further, the first detection area R1, the second detection area R2, and the third detection area R3 are arrayed in this order in the first direction X.

The first detection area R1 comprises a detection electrode 51, a pressure-sensitive layer 71, and a transistor 31 (not shown). The pressure-sensitive layer 71 overlaps the detection electrode 51 in plan view. In the example in FIG. 7, the detection electrode 51 and the pressure-sensitive layer 71 each have a rectangular shape of the same size in plan view, although the pressure-sensitive layer 71 may have a size in plan view smaller than that of the detection electrode 51.

The second detection area R2 comprises a detection electrode 52, a pressure-sensitive layer 72, and a transistor 32 (not shown). The pressure-sensitive layer 72 overlaps the detection electrode 52 in plan view. In the example in FIG. 7, the detection electrode 52 and the pressure-sensitive layer 72 each have a rectangular shape of the same size in plan view, although the pressure-sensitive layer 72 may have a size in plan view smaller than that of the detection electrode 52.

The third detection area R3 comprises a detection electrode 53, a pressure-sensitive layer 73, and a transistor 33 (not shown). The pressure-sensitive layer 73 overlaps the detection electrode 53 in plan view. In the example in FIG. 7, the detection electrode 53 and the pressure-sensitive layer 73 each have a rectangular shape of the same size in plan view, although the pressure-sensitive layer 73 may have a size in plan view smaller than that of the detection electrode 53.

In the example in FIG. 7, the detection electrodes 51, 52, and 53 have the same size in plan view, although at least one of the detection electrodes 51, 52, and 53 may have a size in plan view different from the others. Further, the pressure-sensitive layers 71, 72, and 73 have the same size in plan view, although at least one of the pressure-sensitive layers 71, 72, and 73 may have a size in plan view different from the others.

The pressure sensor 1 of the second embodiment is different from the first embodiment in comprising only one common electrode 64. The common electrode 64 overlaps each of the pressure-sensitive layers 71, 72, and 73 in plan view. For example, the common electrode 64 overlaps the input surface la of the pressure sensor 1 in plan view.

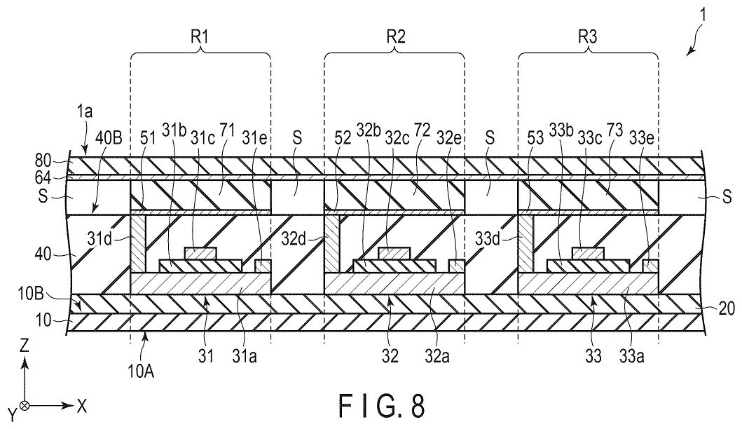

FIG. 8 is a schematic cross-sectional view of the pressure sensor 1 along VIII-VIII line in FIG. 7. Configurations corresponding to those in the first embodiment adopt the above explanations and explanations of these corresponding configurations are omitted.

Each of the detection electrodes 51, 52, and 53 is provided on the surface 40B. The pressure-sensitive layer 71 is provided on the detection electrode 51, the pressure-sensitive layer 72 is provided on the detection electrode 52, and the pressure-sensitive layer 73 is provided on the detection electrode 53.

The common electrode 64 covers each of the pressure-sensitive layers 71, 72, and 73. The common electrode 64 faces each of the detection electrodes 51, 52, and 53. The protective layer 80 is provided on the common electrode 64 to cover it. For example, the common electrode 64 is a metal film formed on a surface of the protective layer 80 on the side opposite to the input surface la. The pressure sensor 1 may not comprise the protective layer 80. In that case, the surface of the common electrode 64 opposite to the surface facing the substrate 10 serves as the input surface 1a.

In this manner, in the pressure sensor 1 of the second embodiment, each of the detection electrodes 51, 52, and 53 is provided to face the common electrode 64. That is, the pressure sensor 1 of the second embodiment comprises what is called a facing-type electrode.

For example, when the input surface la is pressed by fingers and the like, in the first detection area R1, the pressure-sensitive layer 71 is compressed in the Al direction and thus the conductive materials contained in the pressure-sensitive layer 71 are brought into contact with one another or close proximity. This reduces the resistance value of the pressure-sensitive layer 71, and thus a current flows between the detection electrode 51 and the common electrode 64 via the pressure-sensitive layer 71. Pressure applied to the input surface la can be detected by obtaining this current value. Similarly to the first detection area R1, pressure applied to the input surface la can be detected in this manner in the second detection area R2 and the third detection area R3.

The pressure sensor 1 of the second embodiment achieves the same effects of those of the first embodiment.

### Third Embodiment

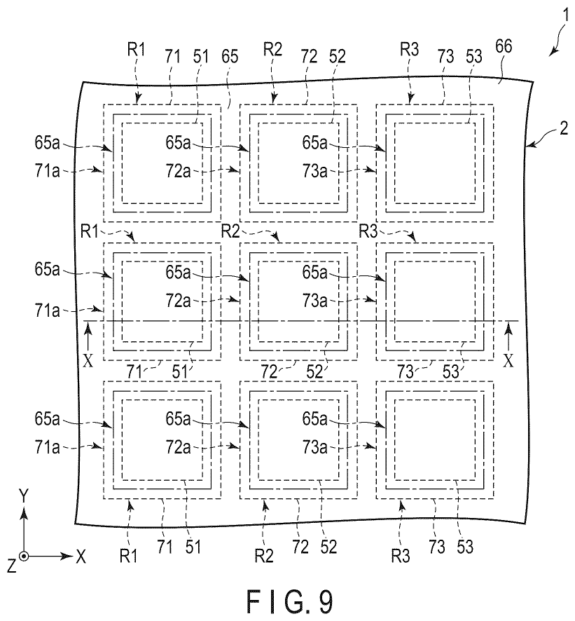

FIG. 9 is a plan view showing a configuration example of a pressure sensor 1 of the third embodiment. Configurations corresponding to those in the first embodiment adopt the above explanations and explanations of these corresponding configurations are omitted. The following describes a detection unit 2 of the pressure sensor 1. FIG. 9 omits the illustration of the protective layer 80.

The pressure sensor 1 has a plurality of first detection areas R1, a plurality of second detection areas R2, and a plurality of third detection areas R3. In the example in FIG. 9, the plurality of first detection areas R1 are arrayed in the second direction Y, the plurality of second detection areas R2 are arrayed in the second direction Y, and the plurality of third detection areas R3 are arrayed in the second direction Y. Further, the first detection areas R1, the second detection areas R2, and the third detection areas R3 are arrayed in this order in the first direction X.

The first detection area R1 comprises a detection electrode 51, a pressure-sensitive layer 71, and a transistor 31 (not shown). The second detection area R2 comprises a detection electrode 52, a pressure-sensitive layer 72, and a transistor 32 (not shown). The third detection area R3 comprises a detection electrode 53, a pressure-sensitive layer 73, and a transistor 33 (not shown).

The pressure sensor 1 of the third embodiment is different from the first embodiment in comprising common electrodes 65 and 66. As shown in long and short dash line in FIG. 9, the common electrode 65 comprises a plurality of apertures 65a. In the example in FIG. 9, the plurality of apertures 65a are arrayed in the first direction X and the second direction Y. For example, the aperture 65a has a rectangular shape in plan view. The common electrode 65 is formed into a lattice shape surrounding the plurality of apertures 65a in plan view. Any of the detection electrodes 51, 52, and 53 is provided in each of the plurality of apertures 65a. Each of the detection electrodes 51, 52, and 53 is spaced apart from the common electrode 65 in the first direction X and the second direction Y and is provided in the aperture 65a.

The pressure-sensitive layer 71 overlaps the detection electrode 51 and the aperture 65a in which the detection electrode 51 is provided in plan view. The peripheral portion 71a of the pressure-sensitive layer 71 overlaps the common electrode 65. The pressure-sensitive layer 72 overlaps the detection electrode 52 and the aperture 65a in which the detection electrode 52 is provided in plan view. The peripheral portion 72a of the pressure-sensitive layer 72 overlaps the common electrode 65 in plan view. The pressure-sensitive layer 73 overlaps the detection electrode 53 and the aperture 65a in which the detection electrode 53 is provided in plan view. The peripheral portion 73a of the pressure-sensitive layer 73 overlaps the common electrode 65.

In the example in FIG. 9, the detection electrodes 51, 52, and 53 have the same size in plan view, although at least one of the detection electrodes 51, 52, and 53 may have a size in plan view different from the others. Further, in the example in FIG. 9, the pressure-sensitive layers 71, 72, and 73 have the same size in plan view, although at least one of the pressure-sensitive layers 71, 72, and 73 may have a size in plan view different from the others.

The common electrode 66 overlaps each of the pressure-sensitive layers 71, 72, and 73 in plan view. Further, the common electrode 66 overlaps the common electrode 65 in plan view. In the example in the figures, the common electrode 66 is formed into a sheet-like shape. For example, the common electrode 66 overlaps the input surface la of the pressure sensor 1 in plan view. The common electrodes 65 and 66 have the same electric potential.

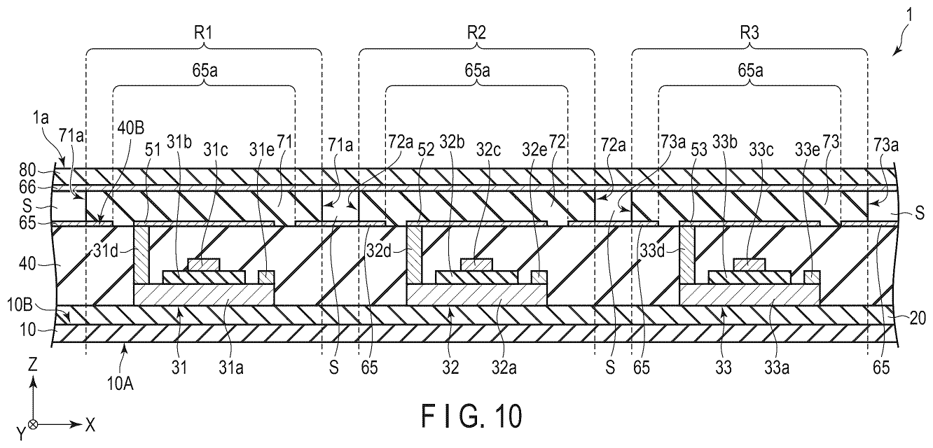

FIG. 10 is a schematic cross-sectional view of the pressure sensor 1 along X-X line in FIG. 9. Configurations corresponding to those in the first embodiment adopt the above explanations and explanations of these corresponding configurations are omitted.

Each of the detection electrodes 51, 52, and 53 is provided on the surface 40B. The common electrode 65 is provided on the surface 40B. That is, each of the detection electrodes 51, 52, and 53 is formed on the same plane as the common electrode 65.

The pressure-sensitive layer 71 covers the detection electrode 51 and the common electrode 65. Further, the pressure-sensitive layer 71 covers the surface 40B between the detection electrode 51 and the common electrode 65. The pressure-sensitive layer 72 covers the detection electrode 52 and the common electrode 65. Further, the pressure-sensitive layer 72 covers the surface 40B between the detection electrode 52 and the common electrode 65. The pressure-sensitive layer 73 covers the detection electrode 53 and the common electrode 65. Further, the pressure-sensitive layer 73 covers the surface 40B between the detection electrode 53 and the common electrode 65.

In the example in FIG. 10, the pressure-sensitive layers 71 and 72 are provided with a gap S interposed therebetween. Further, the pressure-sensitive layers 72 and 73 are provided with the gap S interposed therebetween. The common electrode 65 is exposed in the gap S. Though not shown, a partition formed of an insulating material and the like may be formed in the gap S. Further, the pressure-sensitive layers 71 and 72 may be provided to contact each other, and the pressure-sensitive layers 72 and 73 may be provided to contact each other.

The common electrode 66 covers each of the pressure-sensitive layers 71, 72, and 73. The common electrode 66 faces each of the detection electrodes 51, 52, and 53. The protective layer 80 covers the common electrode 66. For example, the common electrode 66 is a metal film formed on a surface of the protective layer 80 on the opposite side to the input surface la. The pressure sensor 1 may not comprise the protective layer 80. In that case, the surface opposite to the surface facing the substrate 10 of the common electrode 66 serves as the input surface 1a.

In this manner, in the pressure sensor 1 of the third embodiment, each of the detection electrodes 51, 52, and 53 is provided to be on the same plane as the common electrode 65 and to face the common electrode 66. That is, the pressure sensor 1 of the third embodiment comprises a hybrid-type electrode prepared by combining a facing-type electrode and a parallel-type electrode.

For example, when the input surface la is pressed by fingers and the like, in the first detection area R1, the pressure-sensitive layer 71 is compressed in the Al direction and thus the conductive materials contained in the pressure-sensitive layer 71 are brought into contact with one another or close proximity. This reduces the resistance value of the pressure-sensitive layer 71, and thus a current flows between the detection electrode 51 and the common electrode 65 and between the detection electrode 51 and the common electrode 66 via the pressure-sensitive layer 71. Pressure applied to the input surface la can be detected by obtaining this current value. Similarly to the first detection area R1, pressure applied to the input surface la can be detected in this manner in the second detection area R2 and the third detection area R3.

The pressure sensor 1 of the third embodiment achieves the same effects of those of the first embodiment.

### Configuration Example of Arrangement of Detection Area R

### Configuration Example 1

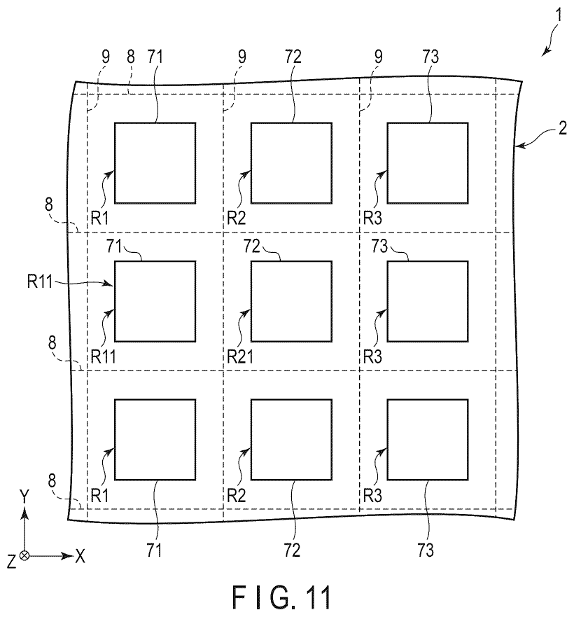

FIG. 11 is a plane view showing a configuration example of arrangements of the detection area R. The following describes the detection unit 2 of the pressure sensor 1.

As shown in FIG. 11, the plurality of gate lines 8 are arrayed in the second direction Y and extend in the first direction X. In addition, the plurality of signal lines 9 are arrayed in the first direction X and extend in the second direction Y.

As shown in FIG. 11, the plurality of first detection areas R1 are arrayed in the second direction Y, the plurality of second detection areas R2 are arrayed in the second direction Y, and the plurality of third detection areas R3 are arrayed in the second direction Y. An area R11, of the plurality of first detection areas, and an area R21, of the plurality of second detection areas, are arrayed in the first direction X. In the example in FIG. 11, the first detection area R1, the second detection area R2, and the third detection area R3 are arrayed in this order in the first direction X. The arrangement order of these areas are not limited to this example.

In the example in FIG. 11, the pressure sensor 1 has the same number of the first detection areas R1, the second detection areas R2, and the third detection areas R3. The numbers of respective areas are not limited to this example and may be different from one another.

Though not shown, the first detection areas R1 may be arrayed in the first direction X, the second detection areas R2 may be arrayed in the first direction X, the third detection areas R3 may be arrayed in the first direction X, and the first detection area R11, of the plurality of first detection areas R1, and the second detection area R21, of the plurality of second detection area R2, may be arrayed in the second direction Y.

### Configuration Example 2

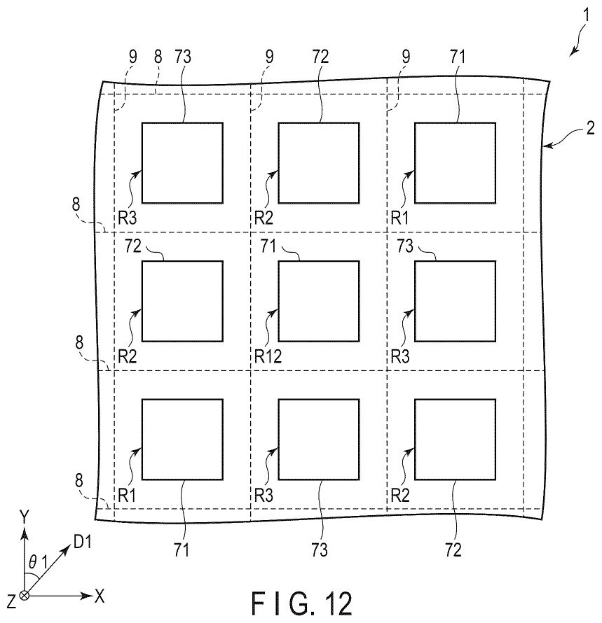

FIG. 12 is a plan view showing another configuration example of arrangements of the detection area R shown in FIG. 11. The following describes the detection unit 2 of the pressure sensor 1. The configuration example shown in FIG. 12 is different from the configuration example 1 shown in FIG. 11 in that the first detection areas R1 being arrayed in a direction different from the first direction X and the second direction Y.

For example, a direction intersecting the second direction Y at an acute angle when seen clockwise is referred to as a direction D1 and an angle formed between the second direction Y and the direction D1 is referred to as an angle θ1. As shown in FIG. 12, the plurality of first detection areas R1 are arrayed in the direction D1, the plurality of second detection areas R2 are arrayed in the direction D1, and the plurality of third detection areas R3 are arrayed in the direction D1. In the example in FIG. 12, the angle θ1 between the second direction Y and the direction D1 is about 45 degrees, but may be other angles. With respect to a first detection area R12, of the plurality of first detection areas R1, in the example in FIG. 12, the first detection area R12 is adjacent to detection areas different from the first detection area R1, in other words, adjacent to the second detection area R2 or the third detection area R3 in the first direction X and the second direction Y.

In the example in FIG. 12, the pressure sensor 1 has the same number of the first detection areas R1, the second detection areas R2, and the third detection areas R3. The numbers of respective areas may be different from one another.

### Configuration Example 3

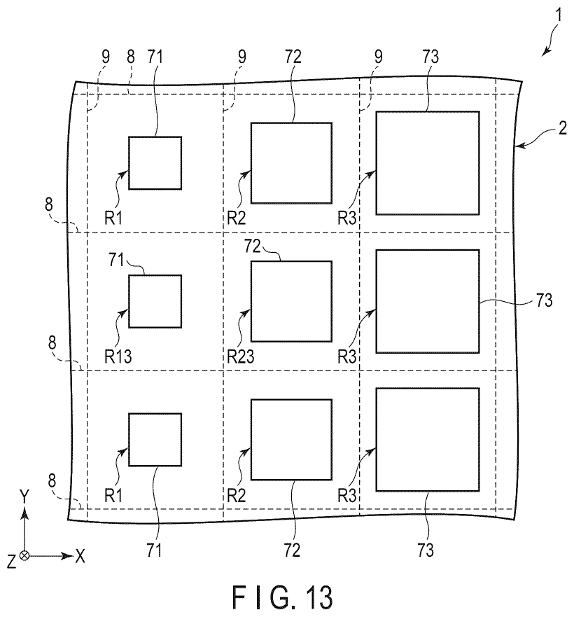

FIG. 13 is a plan view showing another configuration example of arrangements of the detection area R shown in FIG. 11. The following describes the detection unit 2 of the pressure sensor 1. The configuration example 3 in FIG. 13 is different from the configuration example 1 in FIG. 11 in the point that the pressure-sensitive layer 71 of the first detection area R1, the pressure-sensitive layer 72 of the second detection area R2, and the pressure-sensitive layer 73 of the third detection area R3 have different sizes in plan view.

In the example in FIG. 13, the plurality of first detection areas R1 are arrayed in the second direction Y, the plurality of second detection areas R2 are arrayed in the second direction Y, and the plurality of third detection areas R3 are arrayed in the second direction Y. An area R13, of the plurality of first detection areas, and an area R23, of the plurality of second detection areas, are arrayed in the first direction X. Further, the first detection areas R1, the second detection areas R2, and the third detection areas R3 are arrayed in this order in the first direction X.

In the example in FIG. 13, the pressure sensor 1 has the same number of the first detection areas R1, the second detection areas R2, and the third detection areas R3. The numbers of respective areas are not limited to this example and may be different from one another.

As shown in FIG. 13, the pressure-sensitive layers 71, 72, and 73 have different sizes in plan view. In the example in FIG. 13, the size of the pressure-sensitive layer 72 is greater than the pressure-sensitive layer 71, and the size of the pressure-sensitive layer 73 is greater than each of the pressure-sensitive layers 71 and 72 in plan view. The magnitude relationships among these layers are not limited to this example.

This configuration example can enable more sensitive detection of variations in pressures in the detection area that has the broader pressure-sensitive layer. In the example in FIG. 13, the pressure-sensitive layer 73 of the third detection area R3 is particularly great in size. Thus, the variations in the pressure that falls in the range of pressure that can be detected by the third detection area R3 can be detected with high sensitivity in particular.

In the configuration examples in FIG. 11 to FIG. 13, each of the first detection area R1, the second detection area R2, and the third detection area R3 is provided between the plurality of gate lines 8 adjacent to each other in the second direction Y and between the plurality of signal lines 9 adjacent to each other in the first direction X in plan view. Though not illustrated, each of the first detection area R1, the second detection area R2, and the third detection area R3 may overlap the gate line 8 and the signal line 9 in plan view.

The configuration examples in FIG. 11 to FIG. 13 can be applied to any of pressure sensors comprising parallel-type electrodes, pressure sensors comprising facing-type electrodes, and pressure sensors comprising hybrid-type electrodes.

As described above, the present embodiment can provide a pressure sensor capable of detecting variations in pressure in the broader pressure range.

In the present embodiment, for example, the transistor 31 corresponds to the first transistor, the transistor 32 corresponds to the second transistor, the detection electrode 51 corresponds to the first detection electrode, the detection electrode 52 corresponds to the second detection electrode, the pressure-sensitive layer 71 corresponds to the first pressure-sensitive layer, the pressure-sensitive layer 72 corresponds to the second pressure-sensitive layer, the common electrode 61 corresponds to the first common electrode, the common electrode 62 corresponds to the second common electrode, the common electrode 65 corresponds to the lattice-shaped common electrode, and the common electrode 66 corresponds to the sheet-like common electrode.

The present invention is not limited to the embodiments described above. At the stage of implementation, the present invention can be embodied with the constituent elements modified in various manners without departing from the spirit of the invention. Various aspects of the invention can also be extracted from any appropriate combination of a plurality of constituent elements disclosed in each of the embodiments. For example, some structural elements may be deleted from the entire structural elements in the embodiments. Furthermore, structural elements described in different embodiments may be combined suitably.

What is claimed is:

1. A pressure sensor, comprising:
a plurality of first detection areas; and
a plurality of second detection areas, wherein
each of the plurality of first detection areas includes a first transistor, a first detection electrode electrically connected to the first transistor, and a first pressure-sensitive layer provided on the first detection electrode, and
each of the plurality of second detection areas includes a second transistor, a second detection electrode electrically connected to the second transistor, and a second pressure-sensitive layer provided on the second detection electrode, and
the first pressure-sensitive layer and the second pressure-sensitive layer have different variation ratios of resistance values in response to applied pressure.

2. The pressure sensor of claim 1, further comprising:
a plurality of gate lines extending in a first direction; and
a plurality of signal lines extending in a second direction orthogonal to the first direction, wherein
the plurality of first detection areas are arrayed in the second direction, and
one of the plurality of first detection areas and one of the plurality of second detection areas are arrayed in the first direction.

3. The pressure sensor of claim 1, further comprising:
a plurality of gate lines extending in a first direction; and
a plurality of signal lines extending in a second direction orthogonal to the first direction, wherein
the plurality of first detection areas are arrayed in a direction different from the first direction and the second direction.

4. The pressure sensor of claim 1, wherein
the first pressure-sensitive layer and the second pressure-sensitive layer have different sizes in plan view.

5. The pressure sensor of claim 1, wherein
the first detection electrode and the second detection electrode have the same size in plan view.

6. The pressure sensor of claim 1, further comprising:
an insulating layer covering the first transistor and the second transistor; and
one or plurality of common electrodes provided on the insulating layer, and
the first detection electrode and the second detection electrode are provided on the insulating layer.

7. The pressure sensor of claim 6, wherein
the plurality of common electrodes include a plurality of first common electrodes and a plurality of second common electrodes,
each of the plurality of first detection areas comprises the first common electrode,
each of the plurality of second detection areas comprises the second common electrode,
the first detection electrode and the first common electrode are provided on the same plane, and
the second detection electrode and the second common electrode are provided on the same plane.

8. The pressure sensor of claim 7, wherein
the first detection electrode and the first common electrode are adjacent to each other via the first pressure-sensitive layer, and
the second detection electrode and the second common electrode are adjacent to each other via the second pressure-sensitive layer.

9. The pressure sensor of claim 1, further comprising:
a common electrode provided on the first pressure-sensitive layer and the second pressure-sensitive layer.

10. The pressure sensor of claim 9, wherein
each of the first detection electrode and the second detection electrode faces the common electrode.

11. The pressure sensor of claim 1, further comprising:
an insulating layer covering the first transistor and the second transistor;
a lattice-shaped common electrode provided on the insulating layer; and
a sheet-like common electrode provided on the first pressure-sensitive layer and the second pressure-sensitive layer, wherein
the first detection electrode and the second detection electrode are provided on the insulating layer,
the lattice-shaped common electrode includes a plurality of apertures and has a lattice shape surrounding the plurality of apertures in plan view,
each of the first detection electrode and the second detection electrode is provided on any one of the plurality of apertures,
the first detection electrode, the second detection electrode, and the lattice-shaped common electrode are provided on the same plane, and
the sheet-like common electrode faces each of the first detection electrode and the second detection electrode.

12. The pressure sensor of claim 1, wherein
the number of the first detection areas is the same as the number of the second detection areas.

13. The pressure sensor of claim 1, wherein
the number of the first detection areas is different from the number of the second detection areas.

14. The pressure sensor of claim 1, wherein
the first pressure-sensitive layer and the second pressure-sensitive layer each are formed of an insulating resin containing conductive materials.

15. The pressure sensor of claim 14, wherein
the first pressure-sensitive layer and the second pressure-sensitive layer have different contents of the conductive materials contained in the insulating resin.

16. The pressure sensor of claim 14, wherein
the first pressure-sensitive layer and the second pressure-sensitive layer have different conductivities of the conductive materials contained in the insulating resin.

17. The pressure sensor of claim 14, wherein
the first pressure-sensitive layer and the second pressure-sensitive layer have different hardnesses of the insulating resin.
